(19) United States
(12) Patent Application Publication
(10) Pub. No.: US 2026/0311719 A1
(43) Pub. Date: Oct. 8, 2026

(54) MULTI-MODAL CONTROLLABLE VIDEO-TO-AUDIO GENERATION

(71) Applicant: Bytedance Technology Ltd., Grand Cayman (KY)

(72) Inventors: Song BAI, Singapore (SG); Ruifei HE, Beijing (CN); Chuhui XUE, Singapore (SG); Wenqing ZHANG, Singapore (SG); Yingchen YU, Singapore (SG)

(21) Appl. No.: 19/095,514

(22) Filed: Mar. 31, 2025

(51) Int. Cl. G10L 25/57; G06F 40/40; G06V 20/40; G10L 25/18

(52) U.S. Cl. CPC G10L 25/57; G06F 40/40; G06V 20/46; G10L 25/18

(57) ABSTRACT

Example methods, systems and computer-readable media for multi-modal controllable video-to-audio generation are disclosed. One example method includes obtaining a first dataset including multiple audio-text data pairs. A second dataset including multiple video-audio-text data pairs is obtained. For at least one of a specified video-audio-text data pair in the second dataset, one or more audio-text data pairs are selected from the first dataset based on a feature selection method, and one or more curated data samples are created by combining each of the one or more audio-text data pairs from the first dataset with the specified video-audio-text data pair in the second dataset. A video-to-audio (V2A) generation model is trained using the one or more curated data samples.

### TECHNICAL FIELD

The present disclosure relates to computer-implemented methods and systems for multi-modal controllable video-to-audio (V2A) generation.

### BACKGROUND

Audio is an important component of multimedia. Generating vivid audio for videos has become an important technique for enriching user experiences and enhancing content engagement. However, some existing text-to-video (T2V) generation models may not generate accompanying audio for their videos, diminishing the user experience and limiting their practical applicability.

### SUMMARY

The present disclosure involves methods and systems and computer-readable media for multi-modal controllable video-to-audio (V2A) generation. One example method includes obtaining a first dataset including multiple audio-text data pairs. A second dataset including multiple video-audio-text data pairs is obtained. For at least one of a specified video-audio-text data pair in the second dataset, one or more audio-text data pairs are selected from the first dataset based on a feature selection method, and one or more curated data samples are created by combining each of the one or more audio-text data pairs from the first dataset with the specified video-audio-text data pair in the second dataset. A video-to-audio (V2A) generation model is trained using the one or more curated data samples.

The previously described implementation is implementable using a computer-implemented method; a non-transitory, computer-readable medium storing computer-readable instructions to perform the computer-implemented method; and a computer system including at least one computer memory interoperably coupled with at least one hardware processor configured to perform the computer-implemented method or the instructions stored on the non-transitory, computer-readable medium. These and other implementations may each optionally include one or more of the following features.

In some implementations, the feature selection method includes an audio feature selection method, the specified video-audio-text data pair includes a specified video feature, a specified audio feature, and a specified text feature. Selecting the one or more audio-text data pairs from the first dataset based on the feature selection method includes (1) extracting, using a pre-trained multi-modal machine learning (ML) model, multiple audio features from the multiple audio-text data pairs and multiple video-audio-text data pairs; and (2) selecting, from the first dataset and based on the multiple extracted audio features, the one or more audio-text data pairs that include one or more audio features close to the specified audio feature of the specified video-audio-text data pair.

In some implementations, the feature selection method includes a text feature selection (TFS) method, the specified video-audio-text data pair includes a specified video feature, a specified audio feature, and a specified text feature. Selecting the one or more audio-text data pairs from the first dataset based on the feature selection method includes (1) extracting, using a pre-trained multi-modal machine learning (ML) model, multiple text features from the multiple audio-text data pairs and multiple video-audio-text data pairs; and (2) selecting, from the first dataset and based on the multiple extracted text features, the one or more audio-text data pairs that include one or more text features close to the specified text feature of the specified video-audio-text data pair.

In some implementations, the feature selection method includes a random feature selection method, and selecting the one or more audio-text data pairs from the first dataset based on the feature selection method includes randomly selecting the one or more audio-text data pairs from the first dataset.

In some implementations, the first dataset includes a balanced subset and an unbalanced subset.

In some implementations, a video feature in each of the one or more curated data samples includes a specified video feature in the specified video-audio-text data pair.

In some implementations, the specified video-audio-text data pair includes a specified text feature, and a text feature in each of the one or more curated data samples includes a concatenation of a specified text feature in each of the one or more audio-text data pairs and a specified text feature in the specified video-audio-text data pair.

In some implementations, the V2A generation model includes a latent diffusion model (LDM).

In some implementations, the method further includes receiving one or more user signals and one or more video signals. The method includes extracting, using a pre-trained multi-modal ML model and as conditions for the trained V2A generation model, (1) video features from the one or more video signals and (2) user signal features from the one or more user signals. The method includes running, using the conditions for the trained V2A generation model, the trained V2A generation model to generate multiple audio signals for the one or more video signals.

In some implementations, the video features and the user signal features are embedded in a joint embedding space.

In some implementations, the one or more user signals include multi-modality data signals, and the multi-modality data signals include at least two of audio, text, or image signals.

In some implementations, the one or more user signals include a first audio signal, and extracting the user signal features from the one or more user signals includes transforming the first audio signal into a log mel-spectrogram signal.

In some implementations, running the trained V2A generation model includes performing a cross-attention mechanism on the video features.

In some implementations, running the trained V2A generation model includes performing a cross-attention mechanism or applying a feature-wise linear modulation layer on the user signal features.

In some implementations, running the trained V2A generation model includes applying classifier-free guidance (CFG) during a diffusion reverse process.

The subject matter described in this specification can be implemented in particular implementations so as to realize one or more of the following advantages. For example, the techniques described in this specification can enable additional audio to be added during a V2A generation process based on user control signals. The techniques can also ensure strong alignment between input signals, e.g., the video, the user control signals, and the generated audio, thus improving generative quality of the V2A generation process. In some implementations, the alignment can be achieved by utilizing a pre-trained multi-modal machine learning model for its unified embedding space across multiple modalities. In some implementations, the described techniques can curate data ensemble for training the multi-modal controllable V2A generation model, for example, by incorporating a large-scale audio-text dataset as a noisy data pool to mix with video-audio-text samples to obtain training samples. In some implementations, with the curated training data, better model training can be performed, more accurate models can be obtained, and better model prediction results can be achieved. In some implementations, the described techniques can provide a new benchmark with a cross-sample evaluation pipeline for multi-modal controllable V2A generation.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example of a comparison between two video-to-audio (V2A) generation models, according to some implementations.

FIG. 2 illustrates an example system for multi-modal controllable video-to-audio generation, according to some implementations.

FIG. 3 illustrates an example data curation pipeline, according to some implementations.

FIG. 4A illustrates an example spectrogram of a sample text, according to some implementations.

FIG. 4B illustrates an example spectrogram of samples selected by an audio feature selector (AFS) sampling method based on the sample text in FIG. 4A, according to some implementations.

FIG. 4C illustrates an example spectrogram of samples selected by a text feature selector (TFS) sampling method based on the sample text in FIG. 4A, according to some implementations.

FIG. 4D illustrates an example spectrogram of samples selected by a random sampling method based on the sample text in FIG. 4A, according to some implementations.

FIG. 5 illustrate example training data variants of a multi-modal controllable V2A generation model, according to some implementations.

FIG. 6 illustrates comparisons of the multi-modal controllable V2A generation model with three V2A models, according to some implementations.

FIG. 7 illustrate example results for text-based user signals, according to some implementations.

FIG. 8 illustrate illustrates an example ablation study on different training data curation variants on a VGGSound evaluation set, according to some implementations.

FIG. 9 illustrates an example ablation study on multi-condition control, according to some implementations.

FIG. 10 illustrates an example process of multi-modal controllable video-to-audio generation.

FIG. 11 illustrates a schematic diagram of an example computer system, according to some implementations.

Like reference numbers and designations in the various drawings indicate like elements.

### DETAILED DESCRIPTION

Video-to-audio (V2A) generation can generate general sound and sound effects for soundless videos, for example, serving as an automatic sound generating system (e.g., a Foley system or Foley pipeline for creating Foley sound effects). However, some V2A models may be constrained by their reliance on visual input, offering limited control over the generated audio. Some V2A models only take videos as the sole signal to control the process of synthesizing audio, which makes the synthesized content restricted to in-scene objects and users cannot freely inject desirable sound content or sound effects into the generated audio.

This disclosure is directed to methods, systems, and computer-readable media for multi-modal controllable video-to-audio generation. The described techniques can enable audio generation conditioned on various user-provided signals, such as text, images, and audio. In some implementations, a machine learning (ML) model, for example, a pre-trained ImageBind® model, can be used for multi-modal alignment. A large-scale text-audio dataset can be used to facilitate multi-modal controllability. The described techniques can allow highly flexible and precise video-to-audio generation while ensuring consistency between the generated audio and the input signals. The described techniques provides a series of data ensemble strategies, for example, (1) balancing concept diversity and sample diversity via source balancing, and (2) using an AFS to improve audio synchronization. The described techniques can also provide a benchmark with a cross-sample evaluation framework to standardize assessments of multi-modal controllable video-to-audio generation.

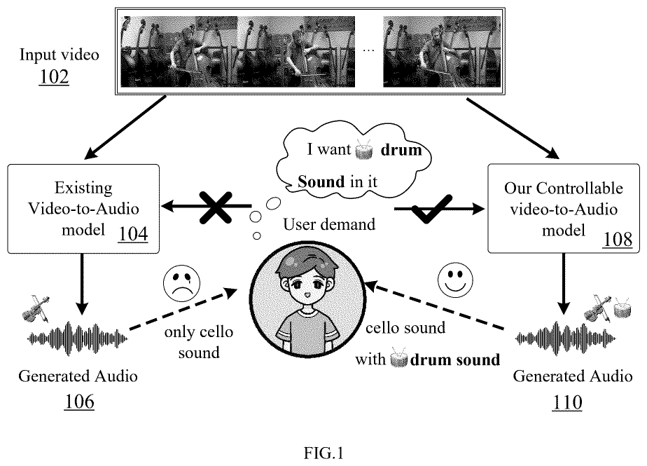

FIG. 1 illustrates an example of a comparison between a conventional V2A generation model 104 and an example proposed V2A generation model 108. As shown in FIG. 1, a user might have his or her own demand for the audio generated from an input video 102, such as adding drum sound to a cello video, which the conventional V2A model 104 fails to manage. In contrast, the V2A model 108, which is a controllable V2A model described in this disclosure, can add the drum sound to the cello video based on the user's demand and achieve proper alignment between the added sound and the input video 102, and thus meet the user's demand.

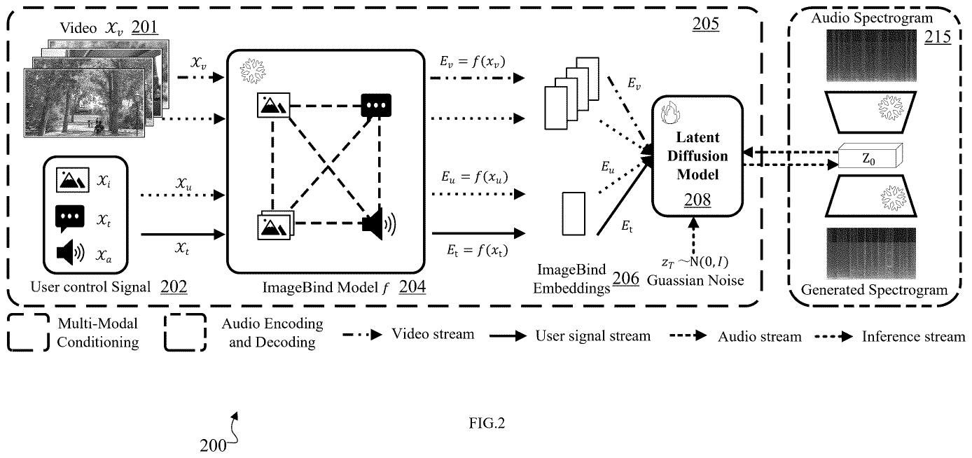

FIG. 2 illustrates an example system 200 for multi-modal controllable video-to-audio generation. System 200 can implement the controllable V2A model 108 in FIG. 1. In some implementations, system 200 can enable users to inject control signals, e.g., multi-modal user control signal 202, into the video-to-audio generation process and produce the desired accompanying audio for a given video 201, e.g., video xᵥ, thereby addressing the diverse and personalized needs of different users. An example of multi-modal user control signal 202 can include one or more of an audio signal xₐ, a text signal xₜ, and/or an image signal xᵢ. One challenge in multi-modal controllable V2A generation lies in how to effectively incorporate the multi-modal control signals into the V2A framework, as alignment across video, audio, text, and image modalities is desirable. Another challenge, however, is the availability and quality of the training data for multi-modal controllable V2A generation. Some existing V2A datasets are relatively small in scope, lacking diversity in the audio samples. More importantly, these datasets only contain aligned video-audio content, while multi-modal controllable V2A generation needs data samples containing signals that can deliver information beyond the visual video content, and also with the accompanying audio covering both the information of the user signal and the video.

The described techniques provide a model and data co-design approach for V2A generation with diversified controls.

In some implementations, from the model perspective, the multi-modal V2A generation can be based on an audio encoding and decoding process 215 with multi-modal conditioning 205. In some implementations, the audio generation can be formulated as a denoising process on spectrogram latent space and solved using a latent diffusion model (LDM). Multi-modal controllability can be achieved by leveraging a pre-trained multi-modal machine learning model, for example, a pre-trained ImageBind® model, to embed multi-modal control signals into a shared embedding space. The embedded control signals are then used as conditions for the LDM to produce audio. With the advantage of a unified embedding space, the multimodal control signals during training can be circumvent by only training with large-scale available text modality data, and any form of the multi-modal control signals can be applicable during inference. Since the generated audio is not only conditioned on the given video (for example, via a cross-attention mechanism) but also various user control signals, the multi-condition control can be used with LDMs. In some cases, linear controlling via feature-wise linear modulation layer can be implemented in the LDM for user control signals to be used as input to V2A generation, such that users can have flexible controls over the video-to-audio generation process.

In some implementations, from the data perspective, extensive audio-text paired data can be curated from a noisy sample pool to enrich a smaller, high-quality dataset of video-audio-text paired data such as VGGSound for learning. In some cases, concept diversity, sample diversity, and audio synchronization all play important roles in the data curation process. For example, 1) as the noisy sample pool (e.g., AudioSet) is highly class-imbalanced, it is more likely to sample head class samples than tail class ones, resulting in losing concept diversity. In some cases, the balanced subset can be utilized as a split data source to alleviate the loss of concept diversity; 2) while the balanced subset is suitable for concept diversity, its limited data scale leads to losing sample diversity. In some cases, a source balancing strategy can be utilized to balance concept diversity and sample diversity. For example, the balanced subset can be used as the source with 50% frequency and likewise for the unbalanced subset; 3) for generating high-quality samples, audio synchronization matters for a harmonious video-audio pair. In some cases, audio features from the pre-trained multi-modal ML model, e.g., the ImageBind® model, can serve as an important clue for synchronization in selection. An audio feature selection method can be used to improve synchronization and harmony; and 4) in some cases, a trade-off exists between sample diversity and audio synchronization. For example, selecting synchronized audio samples would miss out on samples with large variations and diversity. A good trade-off point may be achieved by combining audio feature selection and random sampling.

In some implementations, evaluation methods for multi-modal controllable V2A generation can be developed and a cross-sample evaluation benchmark, e.g., Control-VGGSound, can be designed for VGGSound dataset. For example, for each sample in an evaluation set, another sample can be randomly selected from the evaluation set and the selected sample's text/image/audio can be taken as the user control signal to interact with the original sample's video-to-audio generation process. The synthesized audio can be compared with the combination of the original sample's and the selected sample's audio for benchmarking.

In some implementations, the proposed model and curation data strategy can be evaluated on the VGGSound dataset and the proposed Control-VGGSound benchmark. Comprehensive experiments show that on VGGSound dataset, the proposed method outperforms a V2A model (e.g., Diff-foley model) on all the metrics, including improving contrastive language-audio pre-training (CLAP) score, which measures a CLAP model-based alignment between real audio and generated audio, from 41.42 (Diff-foley) to 55.64, and reducing Frechet inception distance (FID), which measures the similarity between the distributions of features extracted from real audio and generated audio, from 19.36 (Diff-foley) to 15.20.

In some implementations, various control signals can be injected by users for the video-to-audio generation process. In some cases, different modalities such as video, text, audio, and image have huge gaps and are difficult to utilize or align. In some implementations, the ImageBind® model can be used in learning a joint embedding space for multiple modalities, and thus provide an aligned feature space for various signals, where the embedded features can then be used as conditions for the LDM to generate audio. In some cases, multi-condition control can be incorporated for LDMs.

As shown in FIG. 2, given a multi-modality data sample containing audio, video, text, and image (xₐ, xᵥ, xₜ, xᵢ), xₐ is the audio that will be transformed into log mel-spectrograms x_{spec} ∈ [symbol] ^{T′×M} with M mel basis (T′ as the time axis), xᵥ∈ [symbol] ^{T″×3×H×W} is a video clip with T″ frames xₜ is a text description and xᵢ ∈ [symbol] ^{3×H×W} is an image. In some implementations, a pre-trained multi-modal ML model, for example, ImageBind® model 204, can function as a unified feature extractor f(⋅) that can embed xₐ, xᵥ, xₜ, xᵢ into conditions (also referred to as features or embeddings, e.g., ImageBind® embeddings 206) Eₐ ∈ [symbol] ^{C}, Eᵥ∈ [symbol] ^{T″×C}, Eₜ ∈ [symbol] ^{C}, Eᵢ ∈ [symbol] ^{C}. In some cases, user control signals 202 related condition can be regarded as one condition and video condition as another condition. Since different types of user control signals (e.g., text, audio, and/or image) are embedded into the same feature space (also referred to as a joint embedding space), each type of signal can be an equivalent substitution for another type of signal. Hence, for simplicity, during training text modality can be used to represent all user control signals, and different types of control signals are applicable during inference.

In some implementations, during training, data sample can be simplified into a triplet-paired audio-video-text data (xₐ, xᵥ, xₜ). A LDM, for example, LDM 208 in FIG. 2, can be used to generate xₐ based on xᵥ and xₜ. The LDM learns the reverse diffusion process with a low-dimensional latent space, where the log mel-spectrograms x_{spec} can be compressed into

$${z}_{0} = {ℰ}_{θ} ( {x}_{s p e c} ) ∈ {ℝ}^{{c}^{′} \times \frac{{T}^{′}}{r} \times \frac{M}{r}} ,$$

where r is the compress rate. For the forward process, the LDM performs a diffusion process with a Markov chain to gradually turn the original distribution into a standard Gaussian distribution. The LDM adds noise with a fixed schedule with T timesteps of α₁, . . . , α_{T}, where

$${\overline{α}}_{t} = {\prod }_{i = 1}^{t} {α}_{i} .$$

The concrete process can be written as:

$$q ( {z}_{t} \vert {z}_{t - 1} ) = 𝒩 ( {z}_{t} ; \sqrt{{α}_{t}} {z}_{t - 1} , ( 1 - {α}_{t} ) I ) \qquad ( 1 )$$

$$q ( {z}_{t} \vert {z}_{0} ) = 𝒩 ( {z}_{t} ; \sqrt{{\overline{α}}_{t}} {z}_{0} , ( 1 - {\overline{α}}_{t} ) I ) \qquad ( 2 )$$

During training, the LDM performs the reverse diffusion process, denoising z₀ from the noise estimate ∈_{θ}, which can be formulated by optimizing the following loss function:

$${ℒ}_{L D M} = {𝔼}_{{z}_{0} , t , ϵ} {‖ ϵ - {ϵ}_{θ} ( {z}_{t} , t , {E}_{v} , {E}_{t} ) ‖}_{2}^{2} \qquad ( 3 )$$

Note that different from traditional LDMs that only take one kind of condition, in the proposed model, in some implementations, two or more conditions generated by the pre-trained multi-modal ML model, for example, Eᵥ and Eₜ, can be processed by the LDM. For video condition Eᵥ, a cross-attention mechanism can be performed for conditioning. For the additional text feature conditioning, two conditioning strategies can be used: cross-attention mechanism or feature-wise linear modulation layer. In some cases, linear controlling via a feature-wise linear modulation layer can be implemented for text feature conditioning. As shown in the experimental results described later, with aligned video feature Eᵥ and text feature Eₜ from the pre-trained ImageBind® model, the synthesized audio can be highly relevant and synchronized.

In some implementations, for inference, the reverse process can be sampled with z_{T}~ [symbol] (0, I), and the video condition features Eᵥ can be utilized together with different types of user control signal features Eᵤ=f(xᵤ), where xᵤ can be in different forms covering one or more of a text, audio, and/or image. The detailed sampling process is:

$${p}_{θ} ( {z}_{t - 1} \vert {z}_{t} ) = 𝒩 ( {z}_{t - 1} ; {μ}_{θ} ( {z}_{t} , t , {E}_{v} , {E}_{u} ) , {σ}_{t}^{2} I ) \qquad ( 4 )$$

$${μ}_{θ} ( {z}_{t} , t , {E}_{v} , {E}_{u} ) = \frac{1}{\sqrt{{α}_{t}}} ( {z}_{t} - \frac{1 - {α}_{t}}{\sqrt{1 - {\overline{α}}_{t}}} {ϵ}_{θ} ( {z}_{t} , t , {E}_{v} , {E}_{u} ) ) \qquad ( 5 )$$

$${σ}_{t}^{2} = \frac{1 - {\overline{α}}_{t - 1}}{1 - {\overline{α}}_{t}} ( 1 - {α}_{t} ) \qquad ( 6 )$$

After the generated z₀ is obtained, it can be decoded with a decoder [symbol] to obtain the log mel-spectrograms \hat{x}_{spec}= [symbol] (z₀). Finally, a voice coder (e.g., Griffin-Lim algorithm) can be used to transform \hat{x}_{spec} into a waveform signal.

In some implementations, in the diffusion reverse process, classifier-free guidance (CFG) can be applied. The CFG can guide the reverse process by linearly combining the conditional and unconditional score estimates. For the LDM with multi-condition control, the CFG can be implemented as:

$${\hat{ϵ}}_{θ} ( {z}_{t} , t , {E}_{v} , {E}_{u} ) ← {ωϵ}_{θ} ( {z}_{t} , t , {E}_{v} , {E}_{u} ) + ( 1 - ω ) {ϵ}_{θ} ( {z}_{t} , t , ∅ ) , \qquad ( 7 )$$

where ω is the CFG guidance scale.

In some implementations, video-to-audio datasets such as VGGSound may not fit the task of injecting control signals into the video-to-audio process, since the paired data in these datasets are fully aligned video-audio-text data. In other words, signals that can deliver information beyond the visual information in the video are needed, and also with the accompanying audio covering both the information of the user signal and the video. In some cases, these video-to-audio datasets can be curated to boost learning. In the proposed data curation, two datasets are used as examples: the VGGSound dataset with around 200K video-audio-text paired data, and the AudioSet dataset with over 2.1M available audio-text paired data. Additional or different datasets can be used.

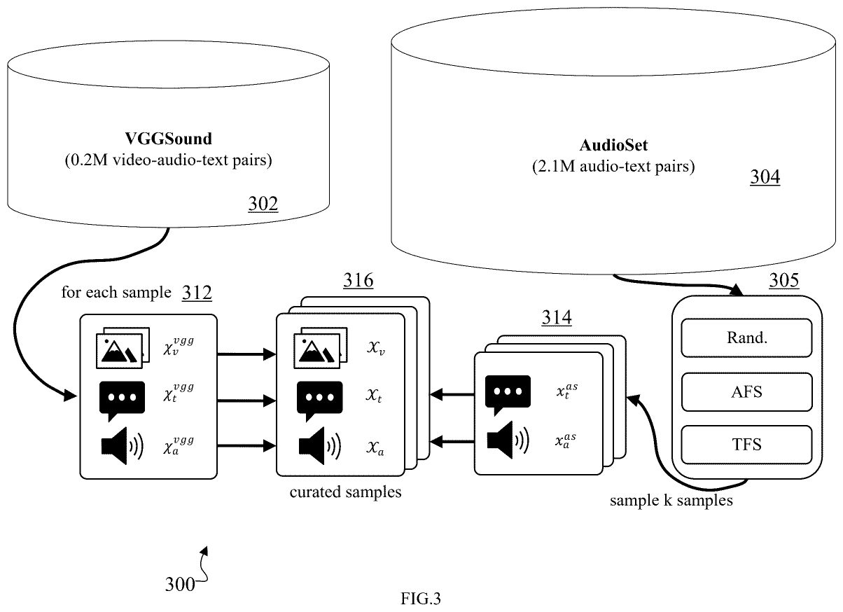

In some implementations, to obtain an ideal sample for the task of injecting control signals into the video-to-audio process, two samples can be merged, mixed, or otherwise combined. FIG. 3 illustrates an example data curation pipeline 300 with two example datasets, a VGGSound dataset 302 and AudioSet dataset 304. As shown in FIG. 3, given a sample

$$( {x}_{a}^{v g g} , {x}_{v}^{v g g} , {x}_{t}^{v g g} )$$

312 from the VGGSound dataset 302 and a sample

$$( {x}_{a}^{a s} , {x}_{t}^{a s} )$$

selected from the AudioSet dataset 304 via one of sampling method 305, a new sample (xₐ, xᵥ, xₜ) 316 can be created, where

$${x}_{v} = {x}_{v}^{v g g} , {x}_{a}$$

is the normalized mixing result of

$${x}_{x}^{v g g} and {x}_{a}^{a s} ,$$

and xₜ is

$$“ {x}_{t}^{x g g} and {x}_{t}^{a s} ” .$$

In this way, a given video can have accompanying audio for video-based content as well as user-given signal based (i.e., text as the control signal) content.

In some implementations, an audio-text paired dataset such as AudioSet can be highly class-imbalanced, with 2 classes out of 527 classes taking up over 98% sample portion. Hence, the whole AudioSet can be split into a balanced subset (~0.02M samples) and an unbalanced subset (~2M samples). In some implementations, the mixing phase of the data curation can include two aspects: mixing sources and sampling methods.

In some implementations, as AudioSet is highly long-tailed, if the whole AudioSet is used as the mixing source directly, head class samples would have a higher sampling rate while tail class ones would rarely be sampled, leading to low concept diversity. In some cases, the balanced subset of AudioSet can be used to preserve concept diversity. However, the balanced subset can suffer from the limited data scale and an extreme lack of sample diversity. Therefore, a source balancing strategy can be used for both concept and sample diversity. For example, the balanced subset can be used as the mixing source with 50% frequency and the unbalanced subset with another 50%. Experiment results show that the source balancing strategy (the “AS-Bal.+ASUn.” variant) outperforms the whole AudioSet sourcing (“AS”) and the balanced AudioSet subset sourcing (“ASBal.”), showing the importance of balancing concept diversity and sample diversity.

In some implementations, a sample method can be used to determine how to select a certain sample from a given source pool. In some cases, random sampling can be used as a baseline sampling method. Other sampling methods are described and compared with the random sample method below. In some implementations, other sampling methods may be able to provide better audio synchronization which is important for mixing two audio tracks than randomly mixing two audio tracks.

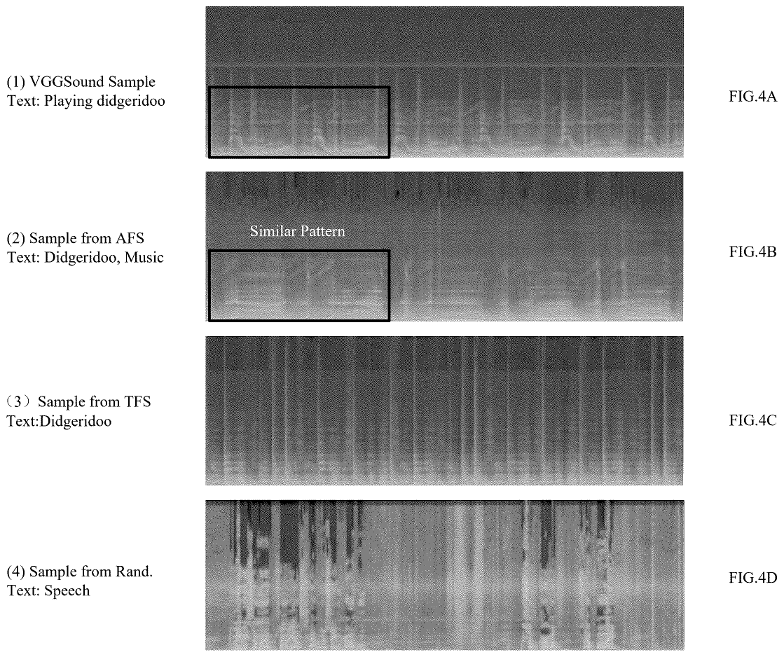

FIG. 4A illustrates an example spectrogram of a sample text. FIG. 4B illustrates an example spectrogram of samples selected by an AFS sampling method based on the sample text in FIG. 4A. FIG. 4C illustrates an example spectrogram of samples selected by a text feature selector (TFS) sampling method based on the sample text in FIG. 4A. FIG. 4D illustrates an example spectrogram of samples selected by a random sampling method based on the sample text in FIG. 4A. As shown in FIGS. 4A to 4D, for a given VGGSound sample of text tag “Playing didgeridoo” with spectrogram of FIG. 4A, mixing the sample with a “Speech” tagged sample (in FIG. 4D) randomly selected from a source data pool, e.g., an AudioSet dataset, may produce dissonance. Hence, feature-based selection methods may be used to sample more synchronized samples. In some cases, given the aligned ImageBind® embedding space, ImageBind® embeddings (e.g., ImageBind® embeddings 206) can be used to select samples with closer feature distances, helping to improve audio synchronization.

In some cases, two example sampling methods can be used: 1) AFS, and 2) text feature selector (TFS). For example, for a given VGGSound sample

$$( {x}_{a}^{v g g} , {x}_{v}^{v g g} , {x}_{t}^{v g g} )$$

and a given source pool

$$\{ ( {x}_{a}^{a {s}_{1}} , {x}_{t}^{a {s}_{1}} ) , … , ( {x}_{a}^{a {s}_{i}} , {x}_{t}^{a {s}_{i}} ) , … , ( {x}_{a}^{a {s}_{n}} , {x}_{t}^{a {s}_{n}} ) \} ,$$

k samples are selected from the source pool to curate high-quality samples. AFS can calculate the cosine distances between the audio features

$${d}_{i}^{A F S} = cos ( f ( {x}_{a}^{v g g} ) , f ( {x}_{a}^{a {s}_{i}} ) ) ,$$

and select the corresponding samples of the top k scores

$${d}_{i}^{A F S} ;$$

likewise, TFS can calculate

$${d}_{i}^{T F S} = cos ( f ( {x}_{t}^{v g g} ) , f ( {x}_{t}^{a {s}_{i}} ) )$$

and also select the top k

$${d}_{i}^{TFS}$$

samples. As shown in FIG. 4B and FIG. 4C, AFS and TFS can both select samples with close semantic distance (both (2) and (3) are tagged close to “Didgeridoo”), and AFS performs better in selecting samples with similar audio patterns to the VGGSound sample and significantly improves audio synchronization.

In some implementations, although AFS and TFS can help generate more high-quality data samples and improve performance on the VGGSound evaluation set, they may suffer from losing sample diversity as they only mix content-related samples and miss out on combining samples with considerable variations. As a result, AFS and TFS may not perform superior on the proposed Control-VGGSound benchmark. In some cases, there is a trade-off for the data curation between sample diversity and synchronization. Therefore, a trade-off variant of combining random mixing and AFS/TFS can be added since random mixing can help include samples with significant variations. In some cases, with AFS/TFS providing high-quality synchronized samples and random sampling supplementing high variation and diversified samples, the trade-off variants perform well in both the VGGSound evaluation set and the proposed Control-VGGSound benchmark.

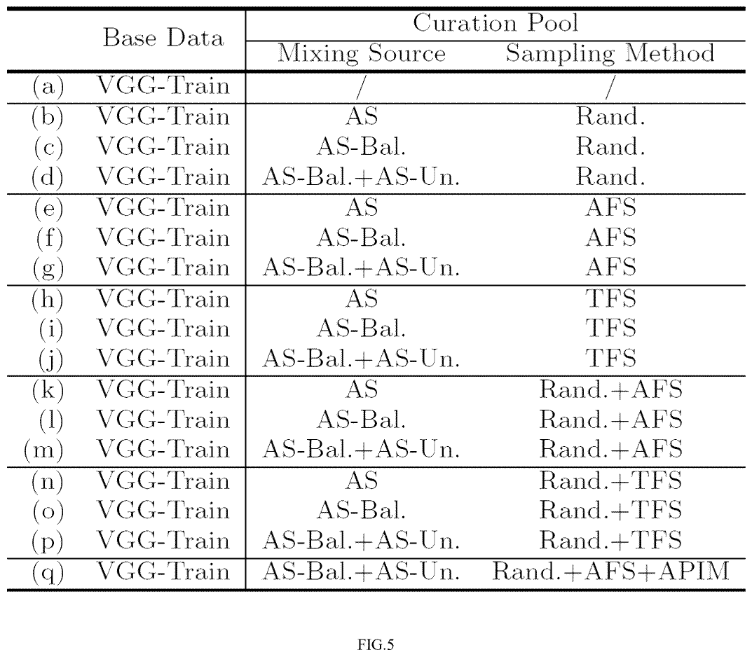

In some implementations, experiments can be conducted for a multi-modal controllable V2A generation model and other V2A models with a VGGSound dataset and curated data from an AudioSet dataset. The VGGSound dataset used in the experiments contains around 200K 10-second video clips and their accompanying audio and text tags, and has 309 classes of general sounds. The AudioSet dataset consists of 2.1M samples from 527 classes. FIG. 5 illustrates example training data variants of the multi-modal controllable V2A generation model. The mixing sources in FIG. 5 include (1) AS: the whole AudioSet; (2) AS-Bal.: the balanced subset of AudioSet; and (3) AS-Bal.+AS-Un.: 50% frequency of the balanced subset of AudioSet, and another 50% of the unbalanced subset of AudioSet. The based data in FIG. 5 is VGG-Train: the training set of VGGSound. The sampling methods in FIG. 5 include (1) Rand.: random sampling; (2) AFS: audio feature selector; and (3) TFS: text feature selector.

Results of training only with the VGGSound dataset are provided, i.e. variant (a) in FIG. 5. For variant (b)~(p), k=4 new samples are generated for each original sample in VGGSound training set (~0.18M), resulting in a 5×size (~0.9M) training set compared with the original VGGSound training set. Moreover, an evaluation benchmark is presented for user signal controllable V2A generation—Control-VGGSound. In some cases, for each sample in a VGGSound evaluation set, another sample is randomly selected from the evaluation set and the selected sample's text/image/audio are taken as the user control signal to interact with the original sample's video-to-audio generation process. Three user signal evaluation tests are presented for text, audio, and image, individually. The synthesized audio is compared with the combination of the original sample's audio and the selected sample's audio for evaluation.

In some implementations, 10-second video clips with 4 frames per second are processed, resulting in 40 frames in total. Afterwards, the video frames are resized to 224×224. For audio data, the original audio is sampled at 16 kHz, and transformed into Mel-spectrograms with mel basis M=128. The hop size is set to 256. For the duration of the video-audio clips, the length is set to 8 seconds. For training, an 8-second video-audio clip is randomly cropped. For inference, the audio for the first 8 second of the given video is generated.

In some implementations, for training the multi-modal controllable V2A generation model, the model is initialized with the pre-trained Stable Diffusion-V1.4 (SD-V1.4), and the frozen pre-trained latent encoder ε and decoder [symbol] from SD-V1.4 is utilized. In some cases, a positional encoding and projection layer τ_{θ} is used to project Eᵥ∈ [symbol] ^{T×C} to appropriate dimension with \tilde{E}ᵥ=τ_{θ}(Eᵥ)=MLP(Eᵥ+PE)∈ [symbol] ^{T×C′}, where MLP is the projection layer, PE represents positional encoding and C′=768. For inference, a diffusion probabilistic model (DPM)-Solver sampler with 25 steps is adopted, and the scale of the CFG is set to 4.5.

In some implementations, Inception Score (IS), Frechet Inception Distance (FID), Mean KL Divergence (MKL), contrastive language-audio pre-training (CLAP) score, and audio-video alignment score (AV-Align) are used for evaluation. IS assesses sample quality and diversity. FID uses frechet inception distance to measure distribution-level similarity. MKL is measured at a paired sample level and reflects the paired-level similarity. CLAP measures the alignment between generated audio and sound classes with CLAP model. AV-Align assesses synchronization between audio and video by detecting audio and video peaks and calculating their Intersection over Union. An audio classifier PANNs is used to calculate the metrics of IS, FID, and MKL.

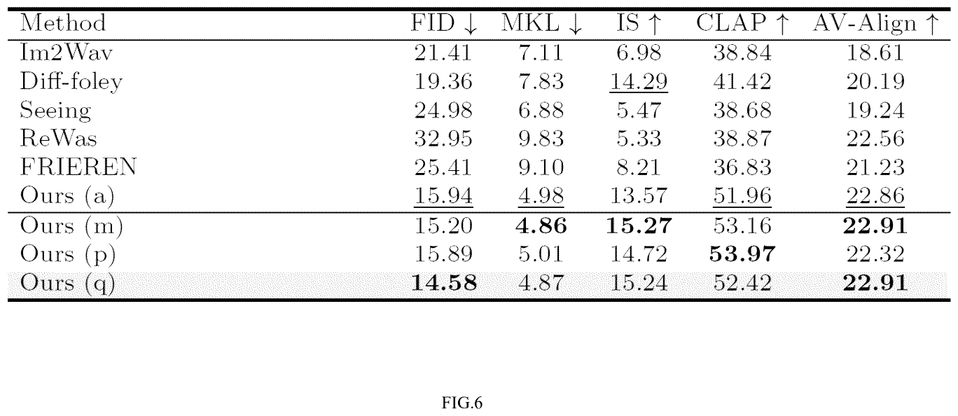

FIG. 6 illustrates comparisons of the multi-modal controllable V2A generation model with three V2A models Im2Wav, Diff-foley, and Seeing and Hearing on the VGGSound evaluation set. The (a), (m), and (p) in FIG. 6 refer to the variants in FIG. 5. Ours (best) in FIG. 6 is the best-achieved performance for each metric from all data variants in FIG. 5. The best results for methods that only train with the VGGSound training set are underlined and the best results across all candidates are in bold. As shown in FIG. 6, variant (a) that only uses the VGGSound training set for learning is compared to the three V2A models. Variant (a) largely reduces FID (19.36→15.94) and MKL (6.88→4.98), and significantly improves CLAP scores (41.42→51.96) and AV-Align (20.19→22.86). As shown in FIG. 6, when equipped with the curated data (with two best-performing variants (m) and (p) shown in FIG. 6), the multi-modal controllable V2A generation model can boost performance and outperform the three V2A models on all metrics, achieving a new state-of-the-art performance.

Additional experiments show that the multi-modal controllable V2A generation model can generate harmonious accompanying audio covering both video content and various user control signals including text, audio and image.

In some implementations, different data variants on Control-VGGSound can be evaluated. Additionally, Diff-foley+AudioLDM can be implemented as a baseline method, which uses Diff-foley to process the video condition and AudioLDM for the text condition, and mixes the generated audio both from Diff-foley and AudioLDM as the final results.

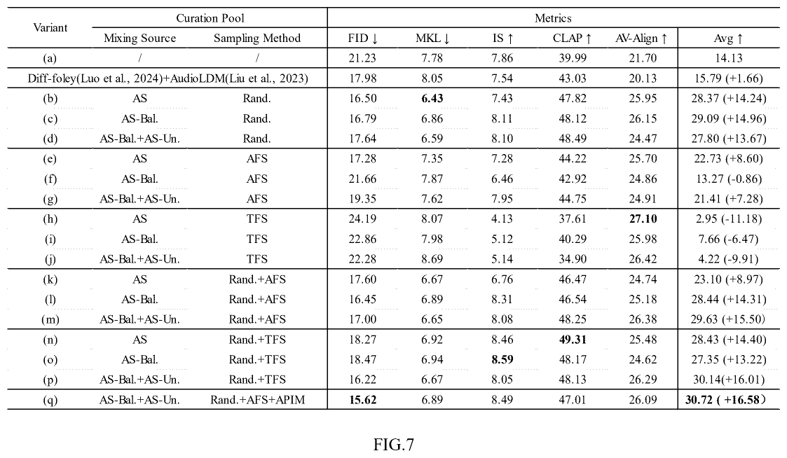

FIG. 7 illustrates results for text-based user signal. Most of the variants in FIG. 5 improve significantly upon the baseline variant (a) and the Diff-foley+AudioLDM baseline, while noticeable performance drops can be observed when only applying AFS or TFS. In some cases, AFS and TFS may lose sample diversity and miss out on mixing samples with large variations, which is important for learning user control signal injection. In contrast, random sampling can be highly effective and robust for multi-modal controllable V2A generation, and combining random sampling with AFS or TFS yields improved results upon baseline (a) and pure random sampling variants. In some cases, for the mixing source, the “AS-Bal.+AS-Un.” source performs the best among the three sources in FIG. 5, and yields the best Avg score of 30.14 together with “Rand.+TFS” (see FIG. 7 variant (p)), and second-best Avg score of 29.63 with “Rand.+AFS” (see FIG. 7 variant (m)), showing the effectiveness of the source balancing strategy. To calculate the Avg score, each metric value is divided with the mean value across all results and ↑ metrics is added and ↓ metrics is subtracted and the resulting score is divided by 5 and multiplied by 100%.

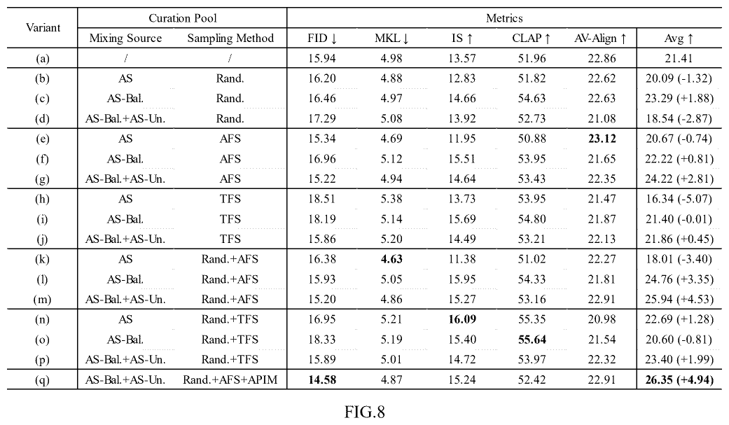

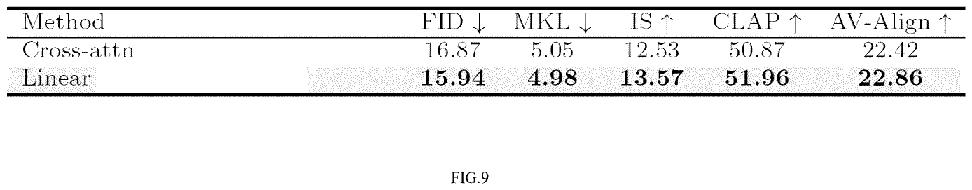

In some implementations, user control signals can be taken as a second condition for video-to-audio generation. FIG. 8 illustrates an example ablation study on different training data curation variants on the VGGSound evaluation set. To calculate the Avg score, each metric value is divided with the mean value across all results and ↑ metrics is added and ↓ metrics is subtracted and the resulting score is divided by 5 and multiplied by 100%. FIG. 9 illustrates ablation study on multi-condition control. The methods in FIG. 9 includes (1) Cross-attn: cross-attention mechanism and (2) Linear: feature-wise linear modulation layer.

In FIG. 9, the cross-attention mechanism (Cross-attn) is compared with the feature-wise linear modulation layer (Linear). FIG. 9 shows that Linear outperforms Cross-attn on all five evaluation metrics.

In some implementations, the data curation strategies can be explored from two perspectives: mixing source and sampling method. With 3 source variants and 5 sampling variants, there can be 15 curated data variants. FIG. 8 shows the results on the VGGSound evaluation set of all 15 variants (b) to (p) in FIG. 5 together with the baseline (a) in FIG. 8. For the mixing source, both “AS-Bal.” and “AS” may hurt the overall performance in some cases due to the trade-off between concept diversity and sample diversity, while “AS-Bal.+AS-Un.” mostly achieves the best performance among the three sources and shows that sourcing balancing can be efficient. For the sampling method, FIG. 8 shows that random sampling largely relies on the balanced data distribution, and introducing the unbalanced data source would lead random sampling to performance degradation (see variants (b), (c), and (d) in FIG. 8). In contrast, feature selection based sampling methods perform more robustly when unbalanced data is introduced as the feature selection based sampling methods only select content-related samples, and AFS shows superior performance and robustness than TFS. However, the characteristic of selecting related samples would also lose sample diversity. To solve this trade-off, combining random sampling and AFS brings out the best in both and achieves the best Avg score of 25.94 with the “AS-Bal.+AS-Un.” source (see variant (m) in FIG. 8).

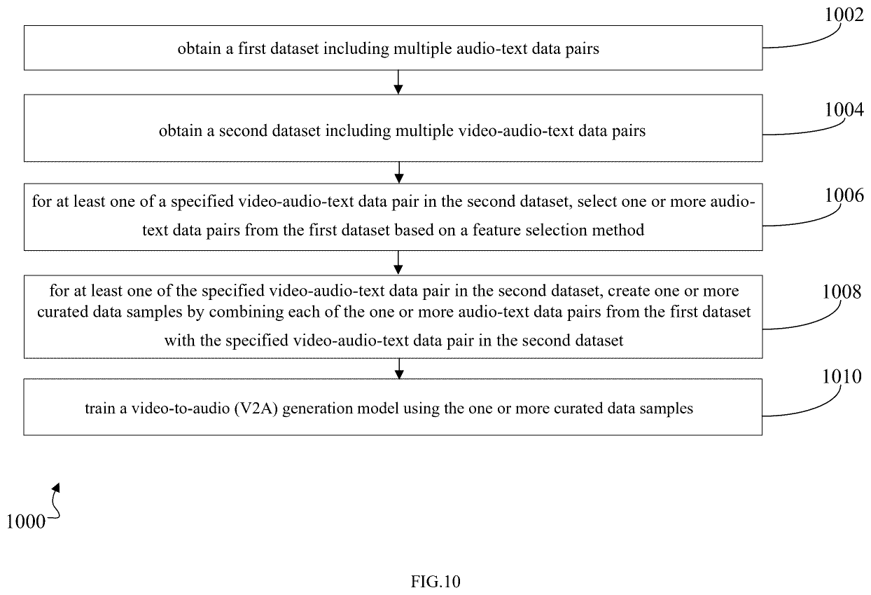

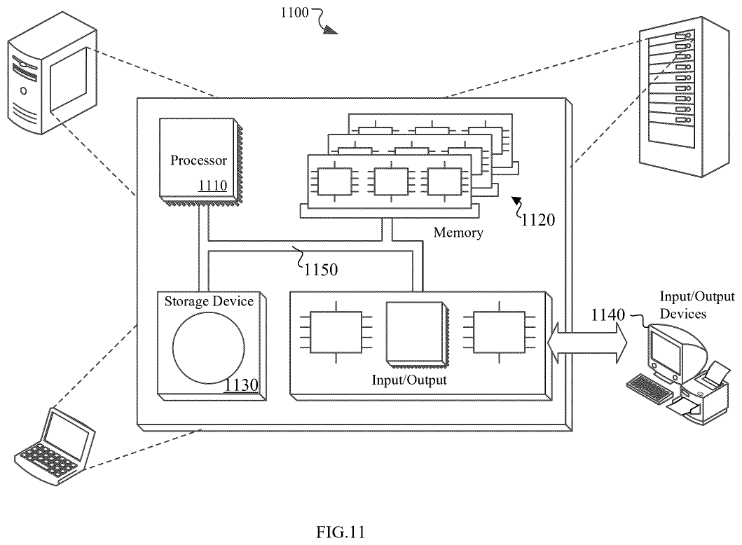

FIG. 10 illustrates an example process 1000 of multi-modal controllable video-to-audio generation. Process 1000 can be performed by any suitable device or system as described herein, for example, according to the example techniques described with respect to FIGS. 1-9. For convenience, process 1000 will be described as being performed by a computer system. An example computer system is computer system 1100 shown in FIG. 11. The operations shown in process 1000 may not be exhaustive and that other operations can be performed as well before, after, or in between any of the illustrated operations. Further, some of the operations may be omitted, performed simultaneously, or in a different order than shown in FIG. 10. In some implementations, some of the operations may be performed by or one or more components of a device or a system.

At 1002, a computer system obtains a first dataset (e.g., AudioSet 304 in FIG. 3) including multiple audio-text data pairs

$$( e . g . , \{ ( {x}_{a}^{a {s}_{1}} , {x}_{t}^{a {s}_{1}} ) , … , ( {x}_{a}^{a {s}_{i}} , {x}_{t}^{a {s}_{i}} ) , … , ( {x}_{a}^{a {s}_{n}} , {x}_{t}^{a {s}_{n}} ) \}$$

described with respect to FIGS. 3 and 4).

At 1004, the computer system obtains a second dataset (e.g., VGGSound 302 in FIG. 3) including multiple video-audio-text data pairs (e.g., multiple pairs of

$$( {x}_{a}^{v g g} , {x}_{v}^{v g g} , {x}_{t}^{v g g} )$$

described with respect to FIGS. 3 and 4).

At 1006, for at least one of a specified video-audio-text data pair (e.g., one video-audio-text data pair or sample

$$( {x}_{a}^{v g g} , {x}_{v}^{v g g} , {x}_{t}^{v g g} )$$

312 described with respect to FIGS. 3 and 4) in the second dataset, the computer system selects one or more audio-text data pairs (e.g., k data pairs or samples

$$( {x}_{a}^{a {s}_{i}} , {x}_{t}^{a {s}_{i}} )$$

314 described with respect to FIGS. 3 and 4, k>=1) from the first dataset based on a feature selection method (e.g., one of AFS, TFS, and random sampling method described with respect to FIGS. 3 and 4 respectively).

At 1008, for at least one of the specified video-audio-text data pair in the second dataset, the computer system creates one or more curated data samples (e.g., curated samples (xₐ, xᵥ, xₜ) 316 in FIG. 3) by combining each of the one or more audio-text data pairs from the first dataset with the specified video-audio-text data pair in the second dataset.

At 1010, the computer system trains a video-to-audio (V2A) generation model (e.g., the LDM 208 in FIG. 2) using the one or more curated data samples, for example, according to the example techniques described with respect to FIG. 2.

In some implementations, the feature selection method includes an audio feature selection method (e.g., audio feature selection in FIGS. 3 and 4B), the specified video-audio-text data pair includes a specified video feature (e.g.,

$${x}_{v}^{vgg}$$

in FIG. 3), a specified audio feature

$$( e . g . , {x}_{a}^{vgg}$$

in FIG. 3), and a specified text feature

$$( e . g . , {x}_{t}^{vgg}$$

in FIG. 3). In some implementations, selecting the one or more audio-text data pairs from the first dataset based on the feature selection method includes (1) extracting, using a pre-trained multi-modal machine learning (ML) model (e.g., the ImageBind® model 204 in FIG. 2), multiple audio features (e.g., Eᵤ in ImageBind® embeddings 206 in FIG. 2) from the multiple audio-text data pairs and multiple video-audio-text data pairs; and (2) selecting, from the first dataset and based on the multiple extracted audio features, the one or more audio-text data pairs that include one or more audio features close to the specified audio feature of the specified video-audio-text data pair. In some cases, the closeness of an audio feature (e.g.,

$${x}_{a}^{{as}_{i}}$$

described with respect to FIG. 4B) to the specified audio feature (e.g.,

$${x}_{a}^{vgg}$$

described with respect to FIG. 4B) of the specified video-audio-text data pair can be determined based on a semantic distance or correlation, e.g., the cosine distance

$${d}_{i}^{AFS} = cos ( f ( {x}_{a}^{vgg} ) , f ( {x}_{a}^{{as}_{i}} ) )$$

described with respect to FIG. 4B, where f represents the pre-trained multi-modal ML model (e.g., the ImageBind® model 204 in FIG. 2). The one or more (e.g., k) audio features in the selected one or more audio-text data pairs have closest semantic distances (e.g., top k correlations or k smallest distances) to the specified audio feature of the specified video-audio-text data pair.

In some implementations, the feature selection method includes a text feature selection (TFS) method (e.g., TFS in FIGS. 3 and 4C), the specified video-audio-text data pair includes a specified video feature (e.g.,

$${x}_{v}^{vgg}$$

in FIG. 3), a specified audio feature (e.g.,

$${x}_{a}^{vgg}$$

in FIG. 3), and a specified text feature (e.g.,

$${x}_{t}^{vgg}$$

in FIG. 3). In some implementations, selecting the one or more audio-text data pairs from the first dataset based on the feature selection method includes (1) extracting, using a pre-trained multi-modal machine learning (ML) model (e.g., the ImageBind® model 204 in FIG. 2), multiple text features (e.g., ImageBind® embeddings Eₜ in FIG. 2) from the multiple audio-text data pairs and multiple video-audio-text data pairs; and (2) selecting, from the first dataset and based on the multiple extracted text features, the one or more audio-text data pairs that include one or more text features close to the specified text feature of the specified video-audio-text data pair. In some cases, the closeness of a text feature (e.g.,

$${x}_{t}^{{as}_{i}}$$

described with respect to FIG. 4C) to the specified text feature (e.g.,

$${x}_{t}^{vgg}$$

described with respect to FIG. 4C) of the specified video-audio-text data pair can be determined by a semantic distance, e.g., the cosine distance

$${d}_{i}^{TFS} = cos ( f ( {x}_{t}^{vgg} ) , f ( {x}_{c}^{{as}_{i}} ) )$$

described with respect to FIG. 4C, where f represents the pre-trained multi-modal ML model (e.g., the ImageBind® model in FIG. 2). The one or more text features in the selected one or more audio-text data pairs have closest semantic distances to the specified text feature of the specified video-audio-text data pair.

In some implementations, the feature selection method includes a random feature selection method (e.g., the random sampling method described with respect to FIG. 4D), and selecting the one or more audio-text data pairs from the first dataset based on the feature selection method includes randomly selecting the one or more audio-text data pairs from the first dataset.

In some implementations, the first dataset includes a balanced subset and an unbalanced subset. Examples of the balanced subset and the unbalanced subset are described with respect to FIG. 3.

In some implementations, a video feature (e.g., xᵥ in FIG. 3) in each of the one or more curated data samples includes a specified video feature (e.g.,

$${x}_{v}^{vgg}$$

in FIG. 3) in the specified video-audio-text data pair.

In some implementations, a text feature (e.g., xₜ in FIG. 3) in each of the one or more curated data samples includes a concatenation of a specified text feature (e.g.,

$${x}_{t}^{as}$$

in FIG. 3) in each of the one or more audio-text data pairs and a specified text feature (e.g.,

$${x}_{t}^{vgg}$$

in FIG. 3) in the specified video-audio-text data pair.

In some implementations, the V2A generation model comprises a LDM (e.g., the LDM 208 in FIG. 2).

In some implementations, the computer system can perform one or more training and inference processes for multi-modal controllable V2A generation, for example, according to techniques described with respect to FIG. 2. For example, in an example training process, the computer system can perform the aforementioned 1002 through 1010 to train LDM 208 in FIG. 2, which, after training, can be used as the multi-modal controllable V2A generation model in the inference process. Additional features described in the aforementioned implementations can be included in the example training process. For example, the pre-trained ImageBind® model 204 in FIG. 2 can be used to extract the multiple audio features and the multiple text features from data in the first dataset and the second data set, as described in the related implementations above. The extracted multiple audio and text features can then be used to create the one or more curated data samples by combining each of the one or more audio-text data pairs from the first dataset with the specified video-audio-text data pair in the second dataset, as described in 1008 above. The generated one or more curated data samples can then be used to train LDM 208 in FIG. 2, as described in 1010 above.

In some implementations, in an example inference process, the computer system receives one or more user signals (e.g., a user control signal 202 in FIG. 2) and one or more video signals (e.g., a video xᵥ in FIG. 2). The computer system extracts, using a pre-trained multi-modal ML model (e.g., the ImageBind® model 204 in FIG. 2) and as conditions (e.g., ImageBind® embeddings 206 in FIG. 2) for the trained V2A generation model (e.g., trained LDM 208 in FIG. 2), (1) video features (e.g., Eᵥ in ImageBind® embeddings 206 in FIG. 2) from the one or more video signals and (2) user signal features (e.g., Eᵤ in ImageBind® embeddings 206 in FIG. 2) from the one or more user signals. The computer system runs, using the conditions for the trained V2A generation model, the trained V2A generation model to generate multiple audio signals (e.g., the waveform signal from LDM 208 as described with respect to FIG. 2) for the one or more video signals.

In some implementations, the video features and the user signal features are embedded in a joint embedding space (e.g., ImageBind® embeddings 206 in FIG. 2).

In some implementations, the one or more user signals include multi-modality data signals, and the multi-modality data signals comprise at least two of audio (e.g., xₐ in FIG. 2), text (e.g., xₜ in FIG. 2), or image signals (e.g., xᵢ in FIG. 2).

In some implementations, the one or more user signals include a first audio signal (e.g., xₐ in FIG. 2), and extracting the user signal features from the one or more user signals includes transforming the first audio signal into a log mel-spectrogram signal (e.g., a log mel-spectrogram signal in ImageBind® model 204 in FIG. 2).

In some implementations, running the trained V2A generation model includes performing a cross-attention mechanism (e.g., the cross-attention mechanism described with respect to FIG. 2) on the video features.

In some implementations, running the trained V2A generation model includes performing a cross-attention mechanism (e.g., the cross-attention mechanism described with respect to FIG. 2) or applying a feature-wise linear modulation layer (e.g., the feature-wise linear modulation layer described with respect to FIG. 2) on the user signal features.

In some implementations, running the trained V2A generation model includes applying CFG (e.g., the CFG described with respect to FIG. 2) during a diffusion reverse process.

FIG. 11 illustrates a schematic diagram of an example computer system 1100. The system 1100 can be used for the operations described in association with the implementations described herein. For example, the system 1100 may be included in any or all of the server components discussed herein. The system 1100 includes a processor 1110, a memory 1120, a storage device 1130, and an input/output device 1140. The components 1110, 1120, 1130, and 1140 are interconnected using a system bus 1150. The processor 1110 is capable of processing instructions for execution within the system 1100. In some implementations, the processor 1110 is a single-threaded processor. The processor 1110 is a multi-threaded processor. The processor 1110 is capable of processing instructions stored in the memory 1120 or on the storage device 1130 to display graphical information for a user interface on the input/output device 1140s.

The memory 1120 stores information within the system 1100. In some implementations, the memory 1120 is a computer-readable medium. The memory 1120 can be a volatile memory unit or a non-volatile memory unit. The storage device 1130 is capable of providing mass storage for the system 1100. The storage device 1130 is a computer-readable medium. The storage device 1130 may be a floppy disk device, a hard disk device, an optical disk device, or a tape device. The input/output device 1140 provides input/output operations for the system 1100. The input/output device 1140 includes a keyboard and/or pointing device. The input/output device 1140 includes a display unit for displaying graphical user interfaces.

The subject matter and the actions and operations described in this specification can be implemented in digital electronic circuitry, in tangibly embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively, or in addition to, the carrier can be an artificially generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices.

To provide for interaction with a user, the subject matter described in this specification can be implemented on one or more computers having, or configured to communicate with, a display device, e.g., an LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

While this specification contains many specific implementation details, these should not be construed as limitations on the scope of what is being claimed, which is defined by the claims themselves, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining a first dataset comprising a plurality of audio-text data pairs;
obtaining a second dataset comprising a plurality of video-audio-text data pairs;
for at least one of a specified video-audio-text data pair in the second dataset,
selecting one or more audio-text data pairs from the first dataset based on a feature selection method; and
creating one or more curated data samples by combining each of the one or more audio-text data pairs from the first dataset with the specified video-audio-text data pair in the second dataset; and
training a video-to-audio (V2A) generation model using the one or more curated data samples.

2. The computer-implemented method of claim 1, wherein:
the feature selection method comprises an audio feature selection method,
the specified video-audio-text data pair comprises a specified video feature, a specified audio feature, and a specified text feature, and
selecting the one or more audio-text data pairs from the first dataset based on the feature selection method comprises:
extracting, using a pre-trained multi-modal machine learning (ML) model, a plurality of audio features from the plurality of audio-text data pairs of the first dataset and the plurality of video-audio-text data pairs; and
selecting, from the first dataset and based on the plurality of extracted audio features, the one or more audio-text data pairs that comprise one or more audio features close to the specified audio feature of the specified video-audio-text data pair.

3. The computer-implemented method of claim 1, wherein:
the feature selection method comprises a text feature selection (TFS) method,
the specified video-audio-text data pair comprises a specified video feature, a specified audio feature, and a specified text feature, and
selecting the one or more audio-text data pairs from the first dataset based on the feature selection method comprises:
extracting, using a pre-trained multi-modal machine learning (ML) model, a plurality of text features from the plurality of audio-text data pairs and the plurality of video-audio-text data pairs; and
selecting, from the first dataset and based on the plurality of extracted text features, the one or more audio-text data pairs that comprise one or more text features close to the specified text feature of the specified video-audio-text data pair.

4. The computer-implemented method of claim 1, wherein:
the feature selection method comprises a random feature selection method, and
selecting the one or more audio-text data pairs from the first dataset based on the feature selection method comprises randomly selecting the one or more audio-text data pairs from the first dataset.

5. The computer-implemented method of claim 1, wherein the first dataset comprises a balanced subset and an unbalanced subset.

6. The computer-implemented method of claim 1, wherein a video feature in each of the one or more curated data samples comprises a specified video feature in the specified video-audio-text data pair.

7. The computer-implemented method of claim 1, wherein the specified video-audio-text data pair comprises a specified text feature, and a text feature in one of the one or more curated data samples comprises a concatenation of the specified text feature in the specified video-audio-text data pair and a text feature extracted from one of the one or more audio-text data pairs.

8. The computer-implemented method of claim 1, wherein the V2A generation model comprises a latent diffusion model (LDM).

9. The computer-implemented method of claim 1, further comprising:
receiving one or more user signals;
receiving one or more video signals;
extracting, using a pre-trained multi-modal ML model and as conditions for the trained V2A generation model, (1) video features from the one or more video signals and (2) user signal features from the one or more user signals; and
running, using the conditions for the trained V2A generation model, the trained V2A generation model to generate a plurality of audio signals for the one or more video signals.

10. The computer-implemented method of claim 9, wherein the video features and the user signal features are embedded in a joint embedding space.

11. The computer-implemented method of claim 9, wherein the one or more user signals comprise multi-modality data signals, and wherein the multi-modality data signals comprise at least two of an audio signal, a text signal, or an image signal.

12. The computer-implemented method of claim 9, wherein the one or more user signals comprise a first audio signal, and wherein extracting the user signal features from the one or more user signals comprises transforming the first audio signal into a log mel-spectrogram signal.

13. The computer-implemented method of claim 9, wherein running the trained V2A generation model comprises performing a cross-attention mechanism on the video features.

14. The computer-implemented method of claim 9, wherein running the trained V2A generation model comprises performing a cross-attention mechanism or applying a feature-wise linear modulation layer on the user signal features.

15. The computer-implemented method of claim 9, wherein running the trained V2A generation model comprises applying classifier-free guidance (CFG) during a diffusion reverse process.

16. A non-transitory computer-readable medium storing one or more instructions executable by a computer system to perform operations comprising:
obtaining a first dataset comprising a plurality of audio-text data pairs;
obtaining a second dataset comprising a plurality of video-audio-text data pairs;
for at least one of a specified video-audio-text data pair in the second dataset,
selecting one or more audio-text data pairs from the first dataset based on a feature selection method; and
creating one or more curated data samples by combining each of the one or more audio-text data pairs from the first dataset with the specified video-audio-text data pair in the second dataset; and
training a video-to-audio (V2A) generation model using the one or more curated data samples.

17. The non-transitory computer-readable medium of claim 16, wherein:
the feature selection method comprises an audio feature selection method,
the specified video-audio-text data pair comprises a specified video feature, a specified audio feature, and a specified text feature, and
selecting the one or more audio-text data pairs from the first dataset based on the feature selection method comprises:
extracting, using a pre-trained multi-modal machine learning (ML) model, a plurality of audio features from the plurality of audio-text data pairs of the first dataset and the plurality of video-audio-text data pairs; and
selecting, from the first dataset and based on the plurality of extracted audio features, the one or more audio-text data pairs that comprise one or more audio features close to the specified audio feature of the specified video-audio-text data pair.

18. The non-transitory computer-readable medium of claim 16, wherein:
the feature selection method comprises a text feature selection (TFS) method,
the specified video-audio-text data pair comprises a specified video feature, a specified audio feature, and a specified text feature, and
selecting the one or more audio-text data pairs from the first dataset based on the feature selection method comprises:
extracting, using a pre-trained multi-modal machine learning (ML) model, a plurality of text features from the plurality of audio-text data pairs and the plurality of video-audio-text data pairs; and
selecting, from the first dataset and based on the plurality of extracted text features, the one or more audio-text data pairs that comprise one or more text features close to the specified text feature of the specified video-audio-text data pair.

19. A computer-implemented system comprising:
one or more computers; and
one or more computer memory devices interoperably coupled with the one or more computers and having tangible, non-transitory, machine-readable media storing one or more instructions that, when executed by the one or more computers, cause the computer-implemented system to perform one or more operations comprising:
obtaining a first dataset comprising a plurality of audio-text data pairs;
obtaining a second dataset comprising a plurality of video-audio-text data pairs;
for at least one of a specified video-audio-text data pair in the second dataset,
selecting one or more audio-text data pairs from the first dataset based on a feature selection method; and
creating one or more curated data samples by combining each of the one or more audio-text data pairs from the first dataset with the specified video-audio-text data pair in the second dataset; and
training a video-to-audio (V2A) generation model using the one or more curated data samples.

20. The computer-implemented system of claim 19, wherein:
the feature selection method comprises an audio feature selection method,
the specified video-audio-text data pair comprises a specified video feature, a specified audio feature, and a specified text feature, and
selecting the one or more audio-text data pairs from the first dataset based on the feature selection method comprises:
extracting, using a pre-trained multi-modal machine learning (ML) model, a plurality of audio features from the plurality of audio-text data pairs of the first dataset and the plurality of video-audio-text data pairs; and
selecting, from the first dataset and based on the plurality of extracted audio features, the one or more audio-text data pairs that comprise one or more audio features close to the specified audio feature of the specified video-audio-text data pair.
